(19) United States
(12) Patent Application Publication
(10) Pub. No.: US 2020/0158937 A1
(43) Pub. Date: May 21, 2020

(54) BACKLIGHT MODULE

(71) Applicant: QISDA CORPORATION, Taoyuan City (TW)

(72) Inventors: Wei-Jung Chang, Taoyuan City (TW); Bin-Hsun Lee, Taoyuan City (TW); Hsiao-Ping Sung, Taoyuan City (TW)

(21) Appl. No.: 16/442,564

(22) Filed: Jun. 17, 2019

(30) Foreign Application Priority Data
Nov. 21, 2018 (TW) 107141492

(51) Int. Cl. F21V 8/00

(52) U.S. Cl. CPC G02B 6/005

(57) ABSTRACT

A backlight module includes a light-guiding plate, a wavelength conversion layer, and an opaque layer. The light-guiding plate has a light output surface and a side surface. The light output surface has an edge. The side surface is adjacent to the light output surface. The light output surface includes a central portion and a fringe portion. The fringe portion extends along the fringe portion. The wavelength conversion layer covers the central portion. The opaque layer covers the fringe portion, so that light in the light-guiding plate will not emit out of the light-guiding plate directly through the fringe portion to be back light.

### BACKGROUND OF THE INVENTION

### 1. Field of the Invention

The present invention relates to a backlight module, and more particularly to a backlight module with a light-guiding plate.

### 2. Description of the Prior Art

Many backlight modules use a light-guiding plate for guiding light to provide flat back light for but not limited to a liquid crystal panel. However, side surfaces of the light-guiding plate also reflect light, resulting in that the brightness at the circumference of the light output surface of the light-guiding plate is relatively high. If the backlight module uses quantum dots, the light emitted out from the circumference of the backlight module is bluer, which influences image displaying. For a monitor with a narrow rim frame, the phenomena of relatively high brightness and bluer color tone mentioned above are hardly hidden by the rim frame in principle.

### SUMMARY OF THE INVENTION

The present invention provides a backlight module that uses an opaque layer to avoid light inside a light-guiding plate of the backlight module from being emitted out of the light-guiding plate directly from a fringe portion of a light output surface of the light-guiding plate, so as to reduce the phenomenon of relatively high brightness or bluer color tone at the fringe portion.

A backlight module according to the invention includes a light-guiding plate, a wavelength conversion layer, and an opaque layer. The light-guiding plate has a light output surface and a side surface. The light output surface has an edge. The side surface is adjacent to the edge. The light output surface includes a central portion and a fringe portion. The fringe portion extends along the edge. The wavelength conversion layer covers the central portion. The opaque layer covers the fringe portion. Thereby, the opaque layer can avoid light inside the light-guiding plate from being emitted out of the light-guiding plate directly from the fringe portion, so as to reduce the phenomenon of relatively high brightness or bluer color tone at the portion of the light output surface adjacent to the edge.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram illustrating a display device according to an embodiment.

FIG. 2 is an exploded view of the display device in FIG. 1.

FIG. 3 is a section view of the display device along the line X-X in FIG. 1.

FIG. 4 is an exploded view of a backlight module of the display device in FIG. 2.

FIG. 5 is a top view of a light-guiding plate of the backlight module in FIG. 4.

FIG. 6 is a section view of a display device according to another embodiment.

FIG. 7 is a section view of a display device according to another embodiment.

FIG. 8 is a section view of a display device according to another embodiment.

FIG. 9 is a top view of a light-guiding plate of a backlight module of the display device in FIG. 8.

### DETAILED DESCRIPTION

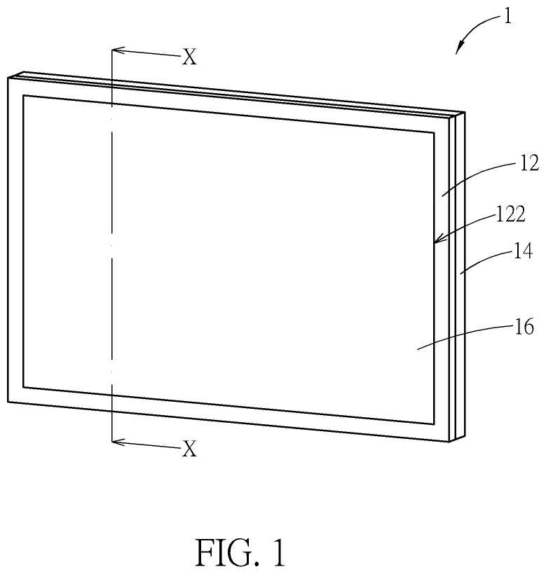

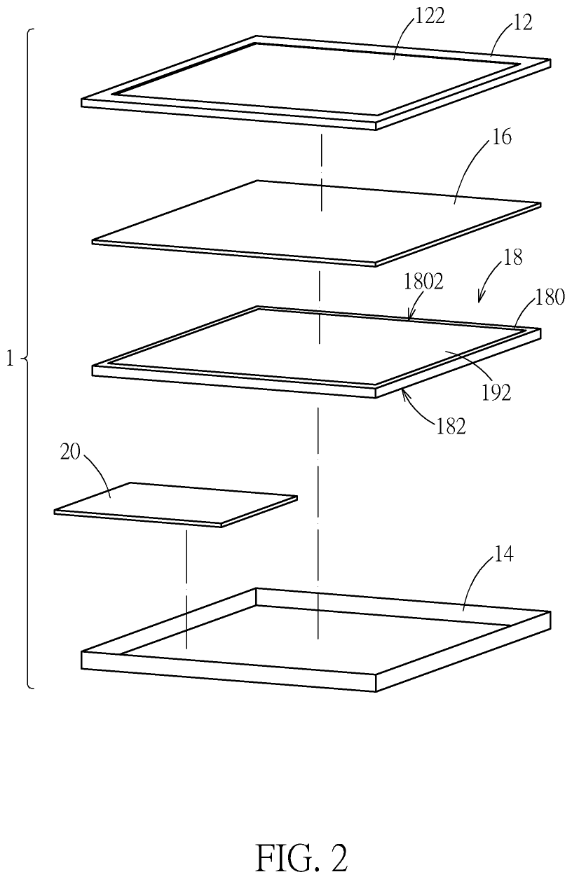

Please refer to FIG. 1 to FIG. 3. A display device 1 according to an embodiment includes a front frame 12, a rear cover 14, a liquid crystal panel 16, a backlight module 18, and a control module 20. The front frame 12 and the rear cover 14 are engaged to form an accommodating space to accommodate other components. The front frame 12 has a window 122, through which the liquid crystal panel 16 is exposed. In practice, the liquid crystal panel 16 can be realized by a common liquid crystal panel, which will not be described in addition. The backlight module 18 is disposed under the liquid crystal panel 16 for providing required back light for the liquid crystal panel 16. The control module 20 is electrically connected to the liquid crystal panel 16 and the backlight module 18 for controlling the operation of the liquid crystal panel 16 and the backlight module 18. For simplification of drawing, the control module 20 is shown by a rectangle in FIG. 2; the electrical connection of the control module 20 with the liquid crystal panel 16 and the backlight module 18 (e.g. by flexible flat cables) is skipped. In practice, the control module 20 can be realized by the control module of a common liquid crystal display (that includes power control circuitry and signal control circuitry and can be realized by one or more circuit boards), which will not be described in addition.

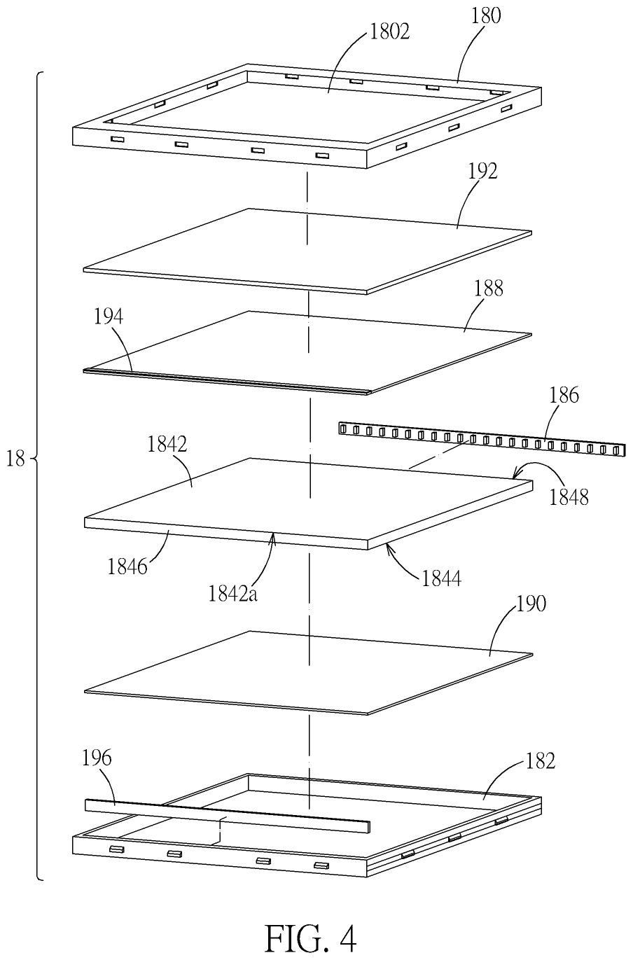

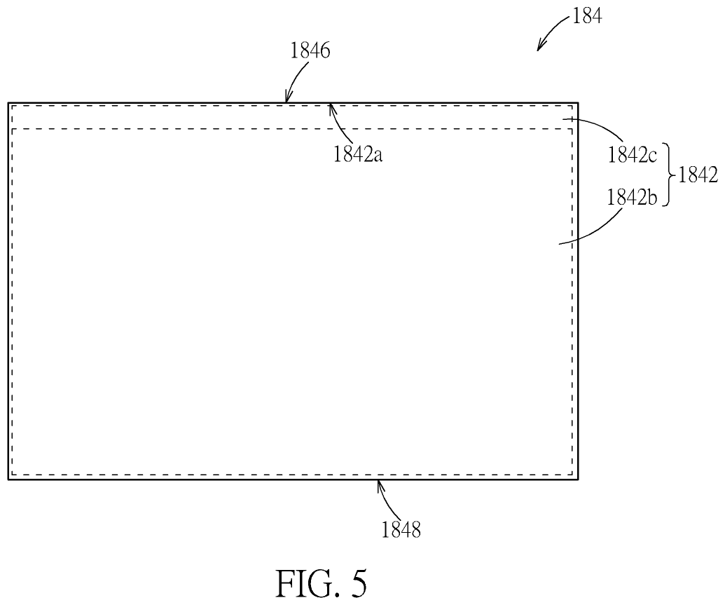

Please also refer to FIG. 4 and FIG. 5. In the embodiment, the backlight module 18 includes a rim frame 180, a base plate 182, a light-guiding plate 184, a light source 186, a wavelength conversion layer 188, a reflective layer 190, and at least one optical film 192 (shown by a single part in the figures for simplifying the figures). The rim frame 180 and the base plate 182 are engaged to form an accommodating space to accommodate other components. The rim frame 180 forms a window 1802. The window 1802 can be larger a little than the window 122 of the front frame 12. The light-guiding plate 184 is disposed above the base plate 182 and has a light output surface 1842, a back surface 1844 opposite to the light output surface 1842, a first side surface 1846, and a second side surface 1848 opposite to the first side surface 1846. The light output surface 1842 faces the window 1802. The light source 186 (e.g. but not limited to a light bar including a plurality of LEDs) is disposed toward the second side surface 1848, so that light emitted by the light source 186 enters into the light-guiding plate 184 through the second side surface 1848. The wavelength conversion layer 188 is disposed above the light output surface 1842. The light inside the light-guiding plate 184 is guided by the light-guiding plate 184 (e.g. through a reflecting structure disposed on the back surface 1844, e.g. by forming indentations on the back surface 1844 or printing reflection spots on the back surface 1844) to be emitted out of the light-guiding plate 184 from the light output surface 1842 and then enter into the wavelength conversion layer 188.

The wavelength conversion layer 188 can convert part of the light into light of a different wavelength, so that the converted light and the un-converted light are mixed together to be the required back light. For example, the un-converted light is blue light, the converted light is red light or green light, and they are mixed to form white light as the back light. In practice, the wavelength conversion layer 188 can be realized by a film containing a plurality of quantum dots or phosphor power, e.g. a common quantum dot film. The reflective layer 190 is disposed between the back surface 1844 and the base plate 182, which can increase the efficiency of the light inside the light-guiding plate 184 that is emitted out from the light output surface 1842. In practice, the reflective layer 190 can be realized by a sheet material, or a coating layer on the back surface 1844 or the base plate 182. The at least one optical film 192 is disposed above the wavelength conversion layer 188 for enhancing the uniformity of the back light. The back light is then emitted out of the backlight module 18 through the window 1802 of the rim frame 180 to be used by the liquid crystal panel 16.

Furthermore, the light output surface 1842 has an edge 1842a. The first side surface 1846 adjoins the edge 1842a. The light output surface 1842 includes a central portion 1842b and a fringe portion 1842c (of which the ranges are indicated by dashed rectangles in FIG. 5). The fringe portion 1842c extends along the edge 1842a. The wavelength conversion layer 188 completely covers the central portion 1842b. The backlight module 18 further includes an opaque layer 194 completely covering the fringe portion 1842c. Thereby, the opaque layer 194 can avoid the light inside the light-guiding plate 184 travelling from the first side surface 1846 toward the fringe portion 1842c from being emitted out of the light-guiding plate 184 directly through the fringe portion 1842c, so as to reduce the phenomenon of relatively high brightness or bluer color tone at the portion of the light output surface 1842 adjacent to the edge 1842a (i.e. the portion of the light output surface 1842 close to the rim frame 180). In practice, the opaque layer 194 is located right under the front frame 12 (or the front frame 12 completely covers the opaque layer 194); that is, before the liquid crystal panel 16 is assembled to the backlight module 18, the opaque layer 194 still cannot be seen through the window 122 in front of the display device 1 in principle. The opaque layer 194 can be made of light-reflective material or light-absorbing material, or material of both, which can be realized by common light-reflective materials or light-absorbing materials and will not be described in addition. If the opaque layer 194 can reflect light, the light usage can be enhanced. If the opaque layer 194 can absorb light, the light brightness at the portion of the backlight module 18 close to the rim frame 180 can be reduced.

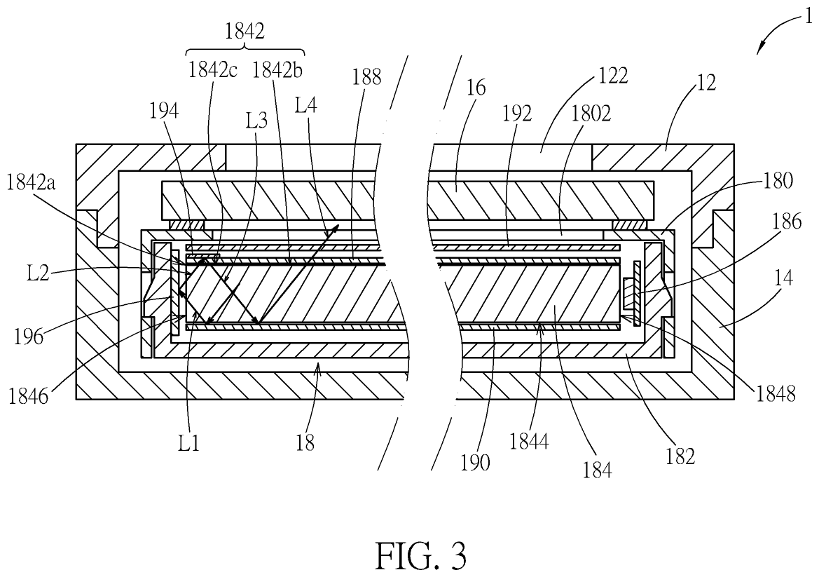

As shown by FIG. 3, in the embodiment, the wavelength conversion layer 188 also covers the fringe portion 1842c and is located between the opaque layer 194 and the light output surface 1842. The opaque layer 194 is, for example, a reflective layer that adheres to the wavelength conversion layer 188 by glue or printing. The backlight module 18 further includes another wavelength conversion layer 196 disposed right opposite to the first side surface 1846. The wavelength conversion layer 196 adheres to a side wall of the base plate 182; however, in practice, it is practicable to attach it onto the first side surface 1846 directly. Thereby, for example, after the light L1 (indicated by an arrow in FIG. 3) inside the light-guiding plate 184 travelling toward the first side surface 1846 is emitted out of the light-guiding plate 184 from the first side surface 1846, the light L1 is reflected by the wavelength conversion layer 196 (or by a side wall of the base plate 182) to enter the light-guiding plate 184 through the first side surface 1846 again. At the moment, the light L2 may contain a portion converted by the wavelength conversion layer 196, and a portion un-converted by the wavelength conversion layer 196.

After the light L2 travels toward the opaque layer 194 and is then emitted out of the light-guiding plate 184 from the light output surface 1842, the light L2 passes through the wavelength conversion layer 188 (i.e. the portion thereof corresponding to the fringe portion 1842c) and is then reflected by the opaque layer 194 to enter the light-guiding plate 184 through the wavelength conversion layer 188 again. At the moment, the light L3 contains the light converted by the wavelength conversion layers 196 and 188. Afterward, after the light L3 is emitted out of the light-guiding plate 184 from the light output surface 1842, the light L3 passes through the wavelength conversion layer 188 (i.e. the portion thereof corresponding to the central portion 1842b) again so as to serve as the back light L4 for the liquid crystal panel 16. In the embodiment, the light L1 to the back light L4 comes through several times of wavelength conversion, so the back light L4 is no longer bluer visually. Furthermore, the position where the light L4 is emitted out of the light output surface 1842 is farther away from the edge 1842a than the position where the light L2 is emitted out of the light output surface 1842, which is conducive to avoidance of brighter back light close to the rim frame 180.

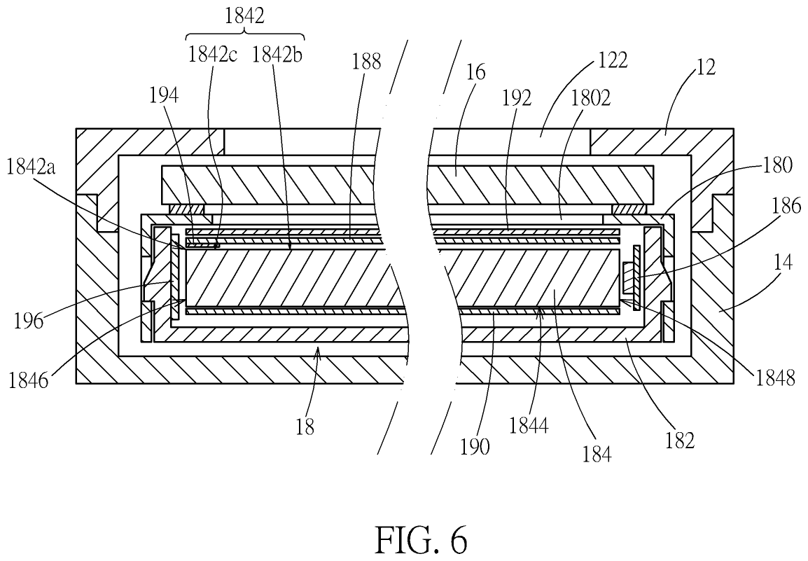

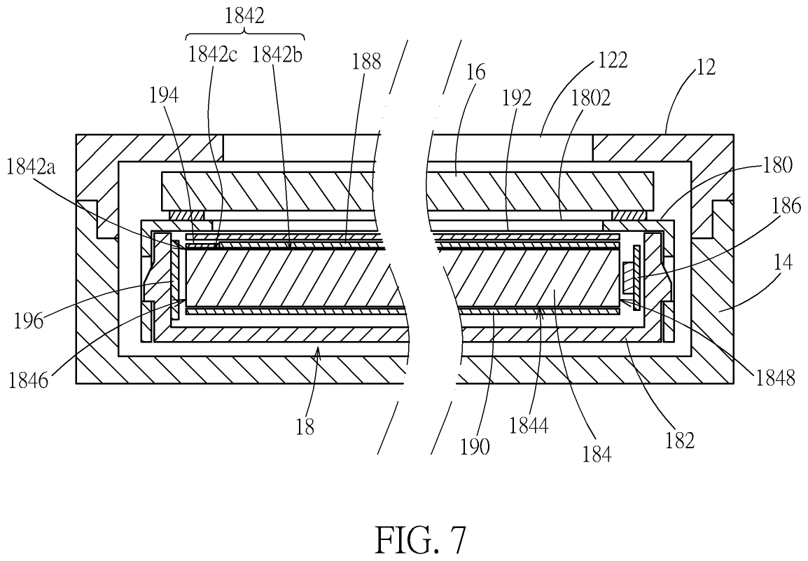

In practice, it is practicable to place the opaque layer 194 between the wavelength conversion layer 188 and the light output surface 1842, as shown by FIG. 6. For this case, the opaque layer 194 can be attached to the wavelength conversion layer 188 or the light-guiding plate 184 by glue or printing. Furthermore, as shown by FIG. 7, the opaque layer 194 directly covers the fringe portion 1842c, so it is practicable to place the wavelength conversion layer 188 without covering the fringe portion 1842c, and the opaque layer 194 can be attached to the fringe portion 1842c by glue or printing. In addition, in practice, the wavelength conversion layer 196 can be replaced with an opaque layer, for which the configuration can be refer to FIG. 3. This opaque layer can be made of light-reflective material or light-absorbing material, or material of both, which can be realized by common light-reflective materials or light-absorbing materials and will not be described in addition. If the opaque layer can reflect light, the light usage can be enhanced. If the opaque layer can absorb light, the light brightness at the portion of the backlight module 18 close to the rim frame 180 can be reduced. In practice, the backlight module 18 can be provided with the above both cases. For example, the backlight module 18 further includes an opaque layer disposed between the wavelength conversion layer 196 and the side wall of the base plate 182.

In addition, as shown by FIG. 3 and FIG. 5, in the embodiment, the backlight module 18 is an edge-lit backlight module. The light emitted by light source 186 enters the light-guiding plate 184 through the second side surface 1848. Because the first side surface 1846 and the second side surface 1848 are located at two opposite sides of the light output surface 1842, there will be a lot of the light travelling toward the second side surface 1848. However, there will also be some of the light travelling toward the other two sides of the light output surface 1842, so the backlight module 18 also can be provided with the opaque layer 194 and the wavelength conversion layer 196 (or variants thereof) mentioned above at these two sides.

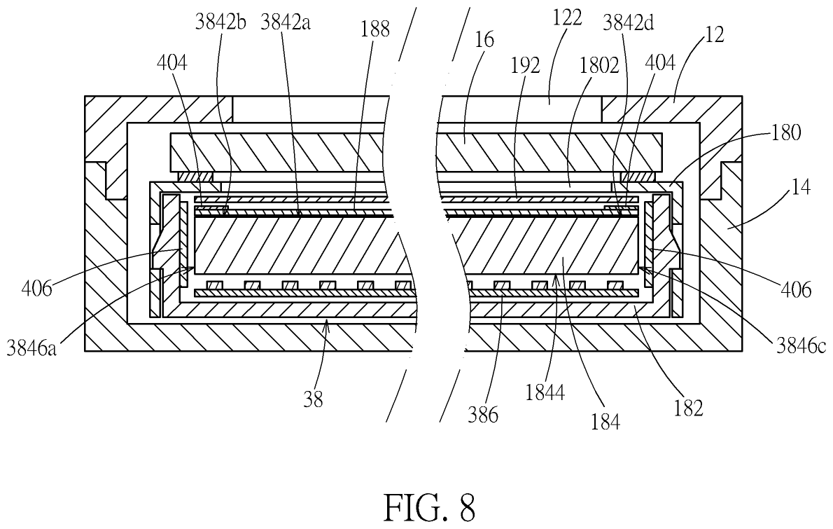

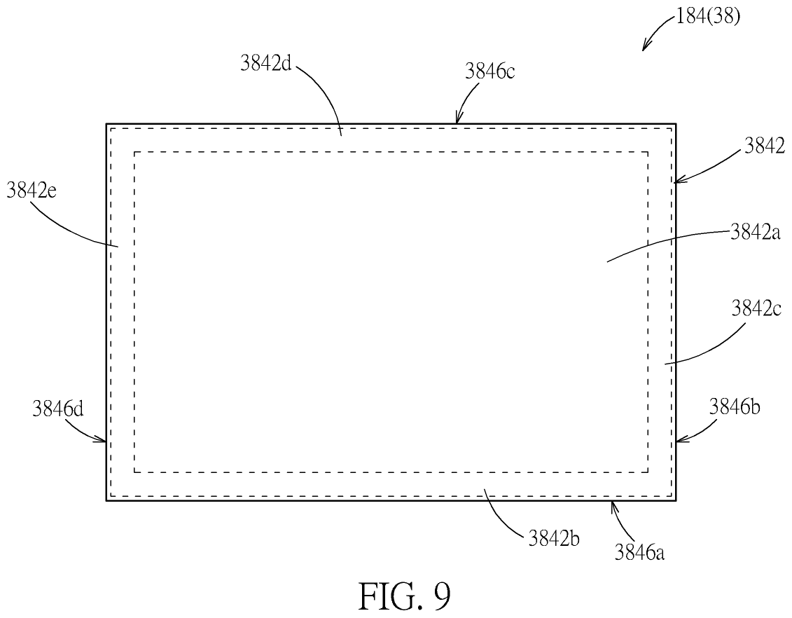

Furthermore, in practice, the backlight module 18 can use a direct light source to be a direct backlight module. As shown by FIG. 8 and FIG. 9, a backlight module 38 of a display device according to another embodiment uses a direct light source 386 (e.g. but not limited to including a circuit board and a plurality of LEDs disposed thereon). For simplification of description and drawing, though the light sources 186 and 386 are different, the backlight module 38 is substantially structurally similar to the backlight module 18. The backlight module 38 still uses the reference numbers of the backlight module 18. For other descriptions of the backlight module 38, please refer to the relevant descriptions of the backlight module 18 and the variants thereof, which will not be described in addition. In the backlight module 38, the light source 386 is disposed toward the back surface 1844 of the light-guiding plate 184. Light emitted by the light source 386 can enter the light-guiding plate 184 through the back surface 1844. Therein, the light-guiding plate 184 of the backlight module 38 and the light-guiding plate 184 of the backlight module 18 are used to guide the light inside the light-guiding plate, so they operates under the same technical concepts. Although they maybe structurally different due to the different directions at which the light enters the light-guiding plate, the structural difference can be understood based on the light-guiding plates of common edge-lit backlight modules and direct backlight modules, which will not be described in addition. Furthermore, the reflective layer 190 can be provided with holes in accordance with the lighting spots (i.e. LEDs) of the light source 386 so as to avoid structural interference to be placed on the light source 386, or the light source 386 is provided with a reflecting structure (e.g. spreading a reflective layer on the circuit board thereof) directly formed thereon so as to omit the reflective layer 190. For simplification of drawing, FIG. 8 does not show the reflective layer 190 or the reflecting structure.

In this embodiment, the light-guiding plate 184 of the backlight module 38 has four side surfaces 3846a-d. The light output surface 3842 of the light-guiding plate 184 has a central portion 3842a and four fringe portions 3842b-e surrounding the central portion 3842a. The fringe portions 3842b-e correspond to the side surfaces 3846a-d respectively. The backlight module 38 includes four opaque layers 404 covering the four fringe portions 3842b-e respectively. The backlight module 38 further includes four wavelength conversion layers 406 disposed right opposite to the four side surfaces 3846a-d respectively. The light inside the light-guiding plate 184 close to the side surfaces 3846a-d may travel toward the side surfaces 3846a-d. Similarly, like the descriptions about the effects of the opaque layer 194 and wavelength conversion layer 196 of the backlight module 18 on the light, the light toward the side surfaces 3846a-d can be reflected by the corresponding wavelength conversion layers 406 back to the light-guiding plate 184, then be reflected by the corresponding opaque layers 404, and then be emitted out of the light-guiding plate 184 through the light output surface 3842. The travelling paths of the light can refer to the relevant descriptions in the foregoing, which will not be described in addition. Thereby, the opaque layer 404 can avoid the light inside the light-guiding plate 184 travelling from the side surfaces 3846a-d toward the fringe portions 3842b-e from being emitted out of the light-guiding plate 184 directly from the fringe portions 3842b-e, so as to reduce the phenomenon of relatively high brightness or bluer color tone at the portion of the light output surface 3842 close to the rim frame 180.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A backlight module, comprising:
a light-guiding plate, having a light output surface and a first side surface, the light output surface having an edge, the first side surface being adjacent to the edge, the light output surface comprising a central portion and a fringe portion, the fringe portion extending along the edge;
a wavelength conversion layer, covering the central portion; and
a first opaque layer, covering the fringe portion.

2. The backlight module according to claim 1, wherein the first opaque layer is made of light-reflective material or light-absorbing material.

3. The backlight module according to claim 1, wherein the wavelength conversion layer covers the fringe portion and is located between the first opaque layer and the light output surface.

4. The backlight module according to claim 1, wherein the wavelength conversion layer covers the fringe portion, and the first opaque layer is located between the wavelength conversion layer and the light output surface.

5. The backlight module according to claim 1, further comprising a second opaque layer, disposed opposite to the first side surface.

6. The backlight module according to claim 5, wherein the second opaque layer is made of light-reflective material or light-absorbing material.

7. The backlight module according to claim 1, further comprising another wavelength conversion layer, disposed opposite to the first side surface.

8. The backlight module according to claim 1, further comprising a light source, wherein the light-guiding plate has a second side surface, and the light source is disposed toward the second side surface.

9. The backlight module according to claim 8, wherein the first side surface and the second side surface are located at two opposite sides of the light output surface.

10. The backlight module according to claim 1, further comprising a light source, wherein the light-guiding plate has a back surface opposite to the light output surface, and the light source is disposed toward the back surface.

11. The backlight module according to claim 1, wherein the wavelength conversion layer comprises a plurality of quantum dots.
